(19) United States
(12) Patent Application Publication
(10) Pub. No.: US 2003/0037084 A1
(43) Pub. Date: Feb. 20, 2003

(54) Adaptive filter control

(76) Inventors: Peter Arthur Walsh, Somerset (GB); Rafel Jibry, Bristol (GB)

Correspondence Address: LOWE HAUPTMAN GILMAN & BERNER, LLP, Suite 310, 1700 Diagonal Road, Alexandria, VA, 22314, US

(21) Appl. No.: 10/189,175

(22) Filed: Jul. 5, 2002

(30) Foreign Application Priority Data
Jul. 7, 2001 (GB) 0116660.2

(51) Int. Cl. G06F 17/10

(52) U.S. Cl. 708/322

(57) ABSTRACT

A method of controlling an adaptive filter in a data channel carrying a signal from which data is to be recovered, the filter having an associated coefficient store and a coefficient temporary store, the method comprising the steps of:

a) applying filter coefficients from the coefficient store to the adaptive filter;

b) adapting the filter coefficients of the adaptive filter in response to the signal on the channel;

c) saving the filter coefficients from the adaptive filter to the temporary store;

d) monitoring at least one signal parameter indicative of signal quality and, if the parameter does not cross a predetermined threshold indicative of coefficient maladaption, then updating the coefficient store with the coefficients from the temporary store and if the parameter crosses the predetermined threshold indicative of coefficient maladaption, then the coefficient store is not updated with the coefficients from the temporary store; and

e) repeating steps a) to d).

THIS INVENTION RELATES to adaptive filter control and more particularly to an adaptive filter control system and method for controlling an adaptive filter by applying stored filter coefficients thereto. The invention extends in general to apparatus and methods for processing data in communication channels.

The role of adaptive filters such as a finite impulse response filter or adaptive waveform equalisers/transversal filters are well known in this technical field. The characteristics of such adaptive filters are automatically adjusted by the application of filter coefficients which shape the response of the filter. The filter coefficients of the adaptive filter are adapted in response to the signal on the data channel to maintain the characteristics of the signal output from the adaptive filter within desired limits.

Typically, the signal which is fed through a data channel and which passes through an adaptive filter includes random data which is held in data segments, which are separated from one another, depending on the format in which the data has been recorded or has been transmitted, by data set separators or tone fields. Because the data set separators or tone fields comprise signals of a constant frequency, these signals are locked onto very easily by the data channel, the adaptive filter tending to converge very quickly down to the data set separator/tone fields. Thus, the adaptive filter will have adapted over the tone fields. This is not ideal because immediately after the tone field has finished, the adaptive filter will be required to readapt and converge onto the random data following the tone field. Such random data is not so easy for the adaptive filter to converge upon so there can be a significant time delay caused by the adaptive filter attempting to reconverge on the random data. Ideally, the adaptive filter should be set to adapt only over random data fields and not over anything else which is not spectrally similar to the data which is to be recovered. The random data fields from which data is intended to be recovered are spectrally rich, whereas examples of spectrally poor data types over which it is preferred that the filter is not adapted. Examples of data which is not spectrally similar to the random data to be recovered comprise tone fields, bad patterns within the random data which are non-random and segments where the data channel is reading from a recording medium upon which nothing has been recorded, for example, a blank tape.

Ideally, the adaptive filter coefficients should be updated only whilst the data channel is passing over a signal indicative of random data and should be constrained from adapting over data separators or tone fields. It is, however, hard to detect the boundary between data separators/tone fields and the random data. Indeed, there can be a twenty to one hundred bit delay in recognising the transition from the data separation/tone field to random data. In order to minimise the time taken for an adaptive filter to converge its filter coefficients to random data settings after the boundary detection, it has previously been proposed to take a snapshot of the coefficients at the end of a data run and store these whilst the data channel passes over bad patterns such as data separators or tone fields and then reapply the snapshot coefficients to the adaptive filter just before the data channel starts to pass over the next segment of random data. An example of the application of such snap-shot coefficients is disclosed in U.S. Pat. No. 5,896,067.

Another approach is taken in JP-A-2-237,307 in which, rather than taking the last available random data filter coefficients from a coefficient store, the coefficient store is provided with coefficients having prescribed nominal values. When the adaptive filter undergoes any transient conditions, the prescribed values for the coefficients can be applied to the adaptive filter.

U.S. Pat. No. 5,896,067 also discloses such a store of nominal coefficients which are implemented when there is a drop-out on the signal on the data channel. This process is referred to as a kick-start procedure, the stored coefficients being referred to as kick-start coefficients.

The prescribed nominal values stored in the coefficient store are not, however, optimised for the type of data flowing through the data channel and it would be better to take the filter coefficients adapted from random data on the data channel—i.e. taking the approach disclosed in U.S. Pat. No. 5,896,067. However, in so doing, the snap-shot coefficients obtained at the end of the data field before the start of a bad pattern may have been the subject of a signal drop-out or the coefficients may have maladapted for some other reason. Thus, “bad” coefficients would have been stored as the snap-shot coefficients which, when reapplied to the subsequent random data field would be sub-optimal causing a delay in the filter converging on the new random data and possibly resulting in data being lost.

EP-A-0 982 861 discloses a method for controlling an adaptive filter in which coefficients are written to a bank of stores, with each set of coefficients held in a store being individually tested to see if they meet an “acceptance threshold” prior to updating the filter coefficients in the filter. If none of the sets of coefficients stored in the stores meet the acceptance threshold, then either a default set of co-efficients are used or the last set of coefficients tested. Whilst co-efficient mal-adaption is tested for, there is still the possibility of maladapted coefficients being applied to the filter since if none of the stored coefficients meet the acceptance threshold despite a number of test iterations, it is the last set of co-efficient which were tested which would be used to operate the filter and this may well be a set of mal-adapted coefficients. Further, it should be noted that multiple tests of the stored coefficients are required prior to selection of an appropriate set of coefficients for use in updating the filter coefficients.

It is an object of the present invention to seek to provide a method of controlling an adaptive filter and an adaptive filter control system which do not suffer from the above mentioned problems.

Accordingly, one aspect of the present invention provides a method of controlling an adaptive filter in a data channel carrying a signal from which data is to be recovered, the filter having an associated coefficient store and a coefficient temporary store, the method comprising the steps of:

a) applying filter coefficients from the coefficient store to the adaptive filter;

b) adapting the filter coefficients of the adaptive filter in response to the signal on the channel;

c) saving the filter coefficients from the adaptive filter to the temporary store;

d) monitoring at least one signal parameter indicative of signal quality and, if the parameter does not cross a predetermined threshold indicative of coefficient maladaption, then updating the coefficient store with the coefficients from the temporary store and if the parameter crosses the predetermined threshold indicative of coefficient maladaption, then the coefficient store is not updated with the coefficients from the temporary store; and

e) repeating steps a) to d).

Preferably, the data to be recovered includes random data held in data segments, the filter coefficients being adapted over data segments only.

Conveniently, step c) is carried out a programmable number of bits before step d).

Advantageously, step c) is carried out a fixed time period before step d).

Preferably, step c) is carried out a fixed number of bits before step d).

Conveniently, the adaptive filter has a filter adaption rate and the number of programmable bits is determined by the filter adaption rate.

Advantageously, the further steps of detecting a boundary between a data segment and a data separator and disabling adaption of the filter in response to said detection and detecting a boundary between a data separator and a data segment and enabling adaption of the filter in response to said further detection.

Preferably, the further steps of detecting a boundary between a data segment and a data separator and disabling adaption for a predetermined time period, then subsequently enabling adaption.

Conveniently, the step of adapting the filter coefficients begins substantially at the start of each data segment and ends substantially at the end of each data segment.

Another aspect of the present invention provides a method of controlling an adaptive filter in a data channel carrying a signal from which data is to be recovered, the filter having an associated coefficient store and a coefficient temporary store, the method comprising the steps of:

a) applying filter coefficients from the coefficient store to the adaptive filter;

b) adapting the filter coefficients of the adaptive filter in response to the signal on the channel;

c) saving the filter coefficients from the adaptive filter to the temporary store;

d) monitoring at least one signal parameter of the equalised signal output indicative of signal quality and, if the parameter does not cross a predetermined threshold indicative of coefficient maladaption, then updating the coefficient store with the coefficients from the temporary store and if the parameter crosses the predetermined threshold indicative of coefficient maladaption, then the coefficient store is not updated with the coefficients from the temporary store; and

e) repeating steps a) to d).

Another aspect of the present invention provides an adaptive filter control system for controlling an adaptive filter in a data channel carrying a signal from which data is to be recovered, the system comprising: an adaptive filter; an adaptive filter control operable to apply filter coefficients from a coefficient store to the adaptive filter; a coefficient maladaption detector operable to monitor at least one signal parameter of the signal indicative of signal quality and set a threshold indicative of coefficient maladaption; a temporary coefficient store addressable by the adaptive filter control; and a coefficient store accessible by the adaptive filter control, wherein the adaptive filter control is operable to update the coefficient store with the coefficients from the temporary store if the signal parameter does not cross the predetermined threshold indicative of coefficient maladaption and if the parameter crosses the predetermined threshold indicative of coefficient maladaption then the coefficient store is not updated with the coefficients from the temporary store.

Advantageously, a boundary detector is provided to tap the signal from the data channel and identify at least one boundary representing a transition between different data types.

Preferably, the boundary detector is operable to enable adaption of the filter in response to the detection of a transition from a first data type to a second data type and to disable adaption of the filter in response to the detection of a transition from the second data type to the first data type or to another data type.

Another aspect of the present invention provides an adaptive filter control system for controlling an adaptive filter in a data channel carrying a signal from which data is to be recovered, the system comprising: an adaptive filter; an adaptive filter control operable to apply filter coefficients from a coefficient store to the adaptive filter; a coefficient maladaption detector operable to monitor at least one signal parameter of the equalised signal output indicative of signal quality and set a threshold indicative of coefficient maladaption; a temporary coefficient store addressable by the adaptive filter control; and a coefficient store accessible by the adaptive filter control, wherein the adaptive filter control is operable to update the coefficient store with the coefficients from the temporary store if the signal parameter does not cross the predetermined threshold indicative of coefficient maladaption and if the parameter crosses the predetermined threshold indicative of coefficient maladaption then the coefficient store is not updated with the coefficients from the temporary store.

In order that the present invention may be more readily understood, embodiments thereof will now be described, by way of example, with reference to the accompanying drawings, in which:

FIG. 1 is a schematic representation of a length of a recording medium having recorded thereon a plurality of data fields separated from one another by tone fields;

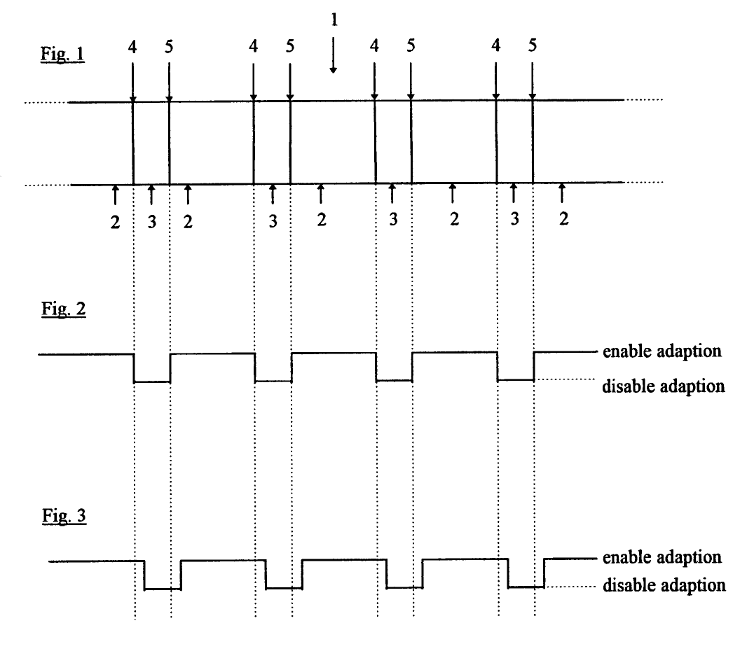

FIG. 2 is a timing diagram synchronised with the data fields of FIG. 1 showing the preferred adaption enablement of an adaptive filter;

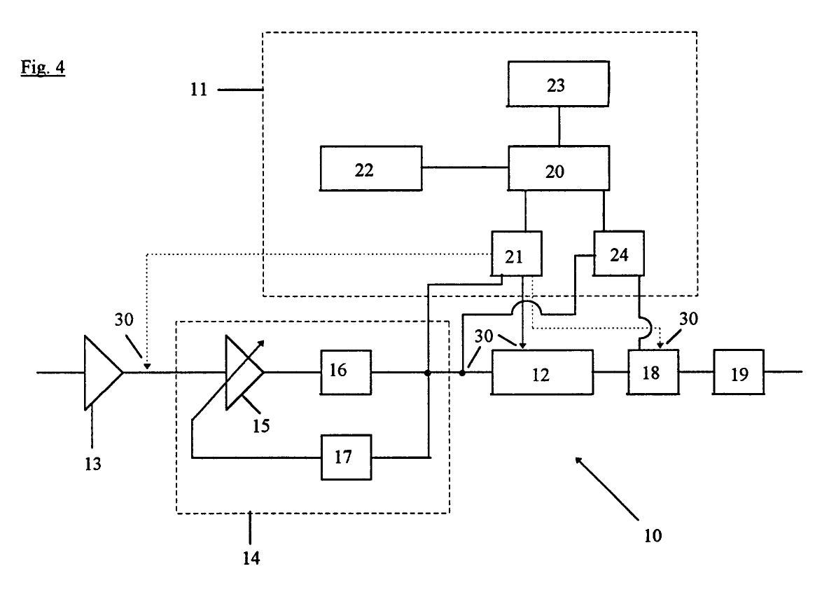

FIG. 3 is a further timing diagram synchronised with FIGS. 1 and 2 showing the timing of tapping of coefficients in accordance with an embodiment of the present invention; and

FIG. 4 is a schematic block diagram of an adaptive filter control system embodying the present invention.

Referring to FIG. 1, an exemplary recording medium 1 such as a length of magnetic tape has recorded thereon a number of data fields 2. The data fields 2 are recorded on the tape 1 in segments which are separated from one another in the present case by data separating fields 3, in this example, tone fields. The particular form of the data separating fields 3 is not important as the characteristics of these will change depending upon the format in which the data has been recorded on the recording medium. However, the principal is the same in that each of the data segments includes random data which is usually spectrally rich, whereas the separating fields are usually spectrally poor and typically comprise a constant frequency signal. There is an end of random data boundary 4 at the end of each data run and an end of separator boundary 5 at the end of each data separator

A data channel running over the recording medium and including an adaptive filter would ideally be enabled to adapt over only the data fields 2 and disabled to prevent adaption over the data separator fields 3. The timing diagram in FIG. 2 shows this idealised relationship. It is, therefore important that the adaption of the filter is synchronised as far as possible to the type of data in the signal over which the data channel is running. There are problems in attempting to synchronise the adaption of the filter with the data type by counting the number of bits before a data boundary 4 between a data segment and a data separator is expected as the signal may experience a drop-out and bits may be lost leading to an incorrect determination of a boundary position. Thus, rather than using dead-reckoning techniques such as bit counting, embodiments of this invention use a detection method to identify the boundary. As previously described in the background section of this application, there will be a delay of a number of bits before a boundary transition 4, 5 is recognised. Such boundary detection techniques are well known in the art, examples of which include a DDS preamble detector and pattern matching a tapped signal with a reference or known pattern.

In reality, as shown in FIG. 3, the optimal timing achievable for enabling adaption of the filter and disabling adaption of the filter is a delayed version of FIG. 2. It will be appreciated that there is a small but acceptable delay from the ideal condition shown in FIG. 2. The delay is of the order of 100 bits. The delay should, in any event, be acceptable if it is short compared to the filter 12 adaption rate (or the adaption time constant).

Referring now to FIG. 4, there is illustrated an exemplary data channel 10. In the present example, the data channel is a data read channel. The components of the data read channel 10 are entirely conventional with the exception of an adaptive filter control 11 which is connected to an adaptive filter 12 of the data channel 10.

The other components of the data channel 10 comprise a preamplifier 13 for receiving a signal from a data read head, for example, an automatic gain control circuit 14 comprising a variable gain amplifier 15, an analogue to digital converter 16, and a feed back loop incorporating an automatic gain control 17. The signal from the automatic gain control circuit 14 is passed to the adaptive filter 12, the output of which is passed to a timing recovery circuit 18 and then to a Viterbi detector, the output of which comprises data recovered from the signal input to the preamplifier 13.

The adaptive filter control circuit 11 comprises an adaptive filter control 20 operable to tap filter coefficients from the adaptive filter 12 and further to apply filter coefficients to the adaptive filter 12. The adaptive filter control 20 also incorporates a maladaption detector 21. A number of measures may be used by the maladaption detector 21 to determine whether the filter coefficients are maladapting. For example, the maladaption detector 21 can tap the signal along the read channel 10 from many points therealong to determine and monitor such metrics as the signal to noise ratio, the noise distribution, the signal amplitude, the rate of change of signal amplitude, the rate of change of the filter coefficients, a phase error in the signal, or the phase in the timing recovery circuit 18. These quality metrics can be used either individually or in combination with one another by tapping the signal from the data read channel at desired points and thereby providing a parameter indicative of the signal quality and, more specifically, indicative of filter coefficient maladaption. It is preferable that the maladaption detector 21 taps into the signal on the read channel as early as possible in the read channel so that any maladaption of the filter coefficients is picked up as soon as possible in the read channel and feedback can be provided to correct such maladaption in a manner to be explained below. In FIG. 4, the maladaption detector 21 is configured to be able to tap into the signal along the read channel 10 at a number of points 30, either individually or in any combination.

The adaptive filter control 20 is further connected to a temporary filter coefficient store 22 and a coefficient register or store 23 which can respectively be configured as a random access memory, register or any other form of data storage device. The adaptive filter control 20 is operable to move data from the temporary filter coefficient store 22 to the coefficient register 23 and is further operable to apply the filter coefficients held in the coefficient register 23 to the adaptive filter 12.

The adaptive filter control 20 also incorporates a boundary detector 24 which is operable to detect the transitions 4, 5 between the spectrally rich random data fields and the spectrally poor data separators or tone fields which it is preferred that the adaptive filter 12 does not adapt over. Preferably, the boundary detector 24 taps the signal on the data channel 10 before the adaptive filter 12 samples the same to detect the boundaries 3 and 5 between data segments 2 and data separators/tone fields 3 and vice versa.

In operation, the signal passing through the data channel 10 is constantly monitored by the boundary detector 24. For the purpose of this example, let us assume that the data channel is presently passing over a random data field and the adaptive filter 12 is adapting its coefficients over the random data. The adaptive filter coefficients from the adaptive filter 12 are being sampled by the adaptive filter controls 20 and the filter coefficients stored in temporary store 22. The maladaption detector 21 also continuously monitors the signal to determine whether there is any maladaption of the filter coefficients in the adaptive filter 12 by monitoring the equalised signal output. On detection of a transition 4 from random data to a data separator or tone field, the boundary detector 24 advises the adaptive filter control 20 which disables adaption of the filter 12. If the maladaption detector 21 has not detected a filter coefficient maladaption event toward the end of the data field 2, then the filter coefficients held in the temporary store 22 are transferred by the adaptive filter control 20 to the filter coefficient register 23.

If, on the other hand, the maladaption detector 21 does detect a maladaption in the filter coefficients towards the end of the data field 2, then no instruction is sent by the adaptive filter control 20 to transfer the filter coefficients from the temporary store 22 to the filter coefficient register 23. Thus, the filter coefficients held in the coefficient register 23 are not updated and are maintained as “good” filter coefficients from random data previously passing through the data channel 10 whereas the filter coefficients in the temporary store 22 are ignored or discarded.

In both circumstances, when the boundary detector 24 detects the transition 5 from the data separator/tone field 3 to the next data segment 2, the filter coefficients stored in the filter coefficient register 23 are transferred by the adaptive filter control 20 into the adaptive filter 12. The adaptive filter 12 then continues to adapt dynamically from the starting point of the filter coefficients held in the coefficient register 23 for the remainder of the data segment 2. The above described operation is then repeated at each transition 4 from data segment 2 to data separator 3 and vice versa.

In a preferred embodiment, if there has been no detected maladaption of the filter coefficients a programmable number of bits after the last filter coefficients were snapshotted and stored in the temporary store 22, then the filter coefficients are transferred by the adaptive filter control 20 from the temporary store 22 into the filter coefficient register 23. It is also possible to use a fixed time period, length of tape or a fixed number of bits as the timing cue for snapshotting if there has been no detected maladaption.

Effectively, the adaptive filter control system embodying the present invention takes snapshots of filter coefficients and looks a programmable number of bits or a fixed time period ahead in the data stream to determine whether the end of the data segment 2 is causing maladaption of the filter coefficients because of some anomaly in the signal on the data channel 10 so that, if the snapshot coefficients are going to be “bad” filter coefficients because they are at the beginning of a maladaption, then those filter coefficients held in the temporary store 22 will not be transferred to the filter coefficient register 23 for subsequent application to the adaptive filter 12 in the next data segment 2. When maladaption is detected and a kickstart event initiated, then the system allows snapshotting of filter coefficients to be disabled for a fixed or variable time period after the kickstart event.

Use of the present invention ensures that the filter coefficients which are stored by the adaptive filter control system and applied to a new data segment are filter coefficients which are as physically close as possible to where they are to be applied along the recording medium. This is important because the physical characteristics of a recording medium such as a tape will change along the length of the tape. Thus, it is advantageous to be able to apply filter characteristics from as close as possible to the end of one data segment to the beginning of the next data segment, hence the need to be able to determine whether the filter coefficients are optimal and can therefore be applied, or whether the filter coefficients have maladapted and should not, therefore, be applied—it being possible to apply, instead, the filter coefficients held in the coefficient register 23 which are known to be “good” filter coefficients.

As previously described, it is preferable that the snap-shot position or positions before the end of data boundary 4 is/are a programmable number of bits before a decision is taken by the maladaption detector 21 as to whether the snapshot coefficients can be passed from the temporary store 22 to the coefficient register 23. Quite how far ahead the system looks, in terms of programmable bits, is determined by the adaption rate of the filter 12. A high adaption rate will require the system to look only tens of bits ahead whereas a low adaption rate will require the system to look thousands of bits ahead.

The present example relates to a single data channel 10. The data channel 10 can, however, be one of a number of channels in a multi-channel system such as the LTO format which operates eight such channels in parallel. The invention is applicable to any form of data channel for application in magnetic tape drives, hard drives, optical storage devices and packetised telecommunications data.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of controlling an adaptive filter in a data channel carrying a signal from which data is to be recovered, the filter having an associated coefficient store and a coefficient temporary store, the method comprising the steps of:
a) applying filter coefficients from the coefficient store to the adaptive filter;
b) adapting the filter coefficients of the adaptive filter in response to the signal on the channel;
c) saving the filter coefficients from the adaptive filter to the temporary store;
d) monitoring at least one signal parameter indicative of signal quality and, if the parameter does not cross a predetermined threshold indicative of coefficient maladaption, then updating the coefficient store with the coefficients from the temporary store and if the parameter crosses the predetermined threshold indicative of coefficient maladaption, then the coefficient store is not updated with the coefficients from the temporary store; and
e) repeating steps a) to d).

2. A method according to claim 1, wherein the data to be recovered includes random data held in data segments, the filter coefficients being adapted over data segments only.

3. A method according to claim 1, comprising the step of carrying out step c) a programmable number of bits before step d).

4. A method according to claim 3, wherein the adaptive filter has a filter adaption rate and the number of programmable bits is determined by the filter adaption rate.

5. A method according to claim 1, comprising the steps of carrying out step c) a fixed time period before step d).

6. A method according to claim 1, comprising the step of carrying out step c) a fixed number of bits before step d).

7. A method according to claim 1, comprising the further steps of detecting a boundary between a data segment and a data separator and disabling adaption of the filter in response to said detection and detecting a boundary between a data separator and a data segment and enabling adaption of the filter in response to said further detection.

8. A method according to claim 1, comprising the further steps of detecting a boundary between a data segment and a data separator and disabling adaption for a predetermined time period, then subsequently enabling adaption.

9. A method according to claim 7, wherein the step of adapting the filter coefficients begins substantially at the start of each data segment and ends substantially at the end of each data segment.

10. A method of controlling an adaptive filter in a data channel carrying a signal from which data is to be recovered, the filter having an associated coefficient store and a coefficient temporary store, the method comprising the steps of:
a) applying filter coefficients from the coefficient store to the adaptive filter;
b) adapting the filter coefficients of the adaptive filter in response to the signal on the channel;
c) saving the filter coefficients from the adaptive filter to the temporary store;
d) monitoring at least one signal parameter of the equalised signal output indicative of signal quality and, if the parameter does not cross a predetermined threshold indicative of coefficient maladaption, then updating the coefficient store with the coefficients from the temporary store and if the parameter crosses the predetermined threshold indicative of coefficient maladaption, then the coefficient store is not updated with the coefficients from the temporary store; and
e) repeating steps a) to d).

11. An adaptive filter control system for controlling an adaptive filter in a data channel carrying a signal from which data is to be recovered, the system comprising: an adaptive filter; an adaptive filter control operable to apply filter coefficients from a coefficient store to the adaptive filter; a coefficient maladaption detector operable to monitor at least one signal parameter of the signal indicative of signal quality and set a threshold indicative of coefficient maladaption; a temporary coefficient store addressable by the adaptive filter control; and a coefficient store accessible by the adaptive filter control, wherein the adaptive filter control is operable to update the coefficient store with the coefficients from the temporary store if the signal parameter does not cross the predetermined threshold indicative of coefficient maladaption and if the parameter crosses the predetermined threshold indicative of coefficient maladaption then the coefficient store is not updated with the coefficients from the temporary store.

12. A system according to claim 11, wherein a boundary detector is provided to tap the signal from the data channel and identify at least one boundary representing a transition between different data types.

13. A system according to claim 12, wherein the boundary detector is operable to enable adaption of the filter in response to the detection of a transition from a first data type to a second data type and to disable adaption of the filter in response to the detection of a transition from the second data type to the first data type or to another data type.

14. An adaptive filter control system for controlling an adaptive filter in a data channel carrying a signal from which data is to be recovered, the system comprising: an adaptive filter; an adaptive filter control operable to apply filter coefficients from a coefficient store to the adaptive filter; a coefficient maladaption detector operable to monitor at least one signal parameter of the equalised signal output indicative of signal quality and set a threshold indicative of coefficient maladaption; a temporary coefficient store addressable by the adaptive filter control; and a coefficient store accessible by the adaptive filter control, wherein the adaptive filter control is operable to update the coefficient store with the coefficients from the temporary store if the signal parameter does not cross the predetermined threshold indicative of coefficient maladaption and if the parameter crosses the predetermined threshold indicative of coefficient maladaption then the coefficient store is not updated with the coefficients from the temporary store.
